(19) United States
(12) Patent Application Publication
(10) Pub. No.: US 2011/0090829 A1
(43) Pub. Date: Apr. 21, 2011

(54) System and method for handsets and access points power saving

(76) Inventor: Jane Zhen Wu, Ottawa (CA)

(21) Appl. No.: 12/662,418

(22) Filed: Apr. 16, 2010

Related U.S. Application Data
(60) Provisional application No. 61/202,929, filed on Apr. 21, 2009.

(51) Int. Cl. H04W 52/02; H04W 88/02; H04W 88/08; G06F 17/30

(52) U.S. Cl. 370/311; 455/550.1; 370/310; 455/561; 707/802; 707/E17.005

(57) ABSTRACT

There is provided a system and a method for a GSM operated handset or access point to turn power on and off and change transmit/receive parameters via GSM device and network. A GSM device is always on while other wireless devices maybe kept power off or in inactive mode. GSM device will turn on/off other devices and instruct them to change transmit and receive parameters according to services availability and radio resource usage policies. Database sever/severs will be equipped for both GSM device and GSM network so that GSM device can aware the services availability and spectrum availability for other devices such as HSPA, 1xEVDo, WiFi, LTE, WiMax, ATSC, DVB-T, DVB-H, etc. A GSM device may turn multiple devices on and enables multiple networks to communicate with a GSM operated handset.

This patent application claims the benefit of priority from U.S. Provisional Patent Application No. 61/202,929 filed on Apr. 21, 2009. This application incorporates by reference the entire disclosure of U.S. Provisional Patent Application No. 61/202,929.

### 1. FIELD OF THE INVENTION

This invention relates generally to the “green energy” and power saving for wireless communication handsets and local access points via GSM network supervision and control.

### 2. BACKGROUND OF THE INVENTION

In the past 10 years, wireless technology has been booming in an enormous way. There are many wireless standards associated with variety of wireless products that are making peoples' life easier and convenient. Those standards include cellular standards such as GSM (Global System for Mobile), IS-95 (Interim Standard 95)/CDMA2000 (Code Division Multiple Access 2000), 3GPP/UMTS/LTE (3^{rd} Generation Partnership Project/Universal Mobile telecommunications System/Long Term Evolution), WiMax/IEEE 802.16e and local area networks standards such as WiFi/IEEE 802.11x, BlueTooth, Zigbee, UWB/IEEE 802.15x. In today's handset or access point (AP), it is very common to find there are multiple wireless radios integrated together such as GSM, CDMA, BlueTooth, WiFi and RFid etc. It will integrate more other emerging technologies these include HSPA (High Speed Packet Access), LTE, WiMax, 802.11n, DVB-H, etc. Those technologies are operating in different frequencies with different protocols which consume a big portion of the power and make the battery life short or waste electricity. There is a need for a “green energy technology” to manage those multiple radios to save energy and to reduce RF (Radio Frequency) pollution.

GSM is a world wide dominant wireless cellular communications system and owns more than 80% of the wireless subscribers. Therefore GSM network has the best coverage so far and its signal is almost everywhere. Beside traditional voice and data services provided, GSM signal can be used as an operation signal to manage other wireless networks such as HSPA, LTE or WiMax or Femto etc. In one scenario, new emerging systems such as LTE and WiMax can be deployed in hot spots or populated areas and leave those uncovered areas to other systems such as GSM or EDGE or CDMA or Femto cells or home gateways. On another scenario, Femto cells or Access points are localized in a much smaller areas therefore services are available only when close to the proximity of those access points or gateways. Outside those coverage areas, the services have to be handed over to other wider area access systems.

The foregoing objects and advantages of the invention are illustrative that can be achieved by various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation that may be apparent or equivalent to those persons skilled in the art. Other particular examples for designing similar “green energy” wireless communication may use CDMA/3GPP2 system or 3GPP/UMTS as the supervision systems which we will not describe here in details. Accordingly, the present invention resides in the novel system concepts, methods, arrangements, combinations, and improvements herein shown and described in various exemplary embodiments.

### 3. SUMMARY OF THE INVENTION

As there are variety wireless systems integrated together, battery or power saving is very important for the future wireless handsets and wireless access points. In this invention, we will disclose how to use GSM system as a supervision system to turn on/off other wireless systems to save the energy and to improve the performance.

We will provide brief summaries of various exemplary embodiments. Some simplifications and omissions may be made in the following summary, which is intended to highlight and introduce some aspects of the various exemplary embodiments, but not to limit the scope of the invention. Detailed descriptions of a preferred exemplary embodiment are adequate to those having skills in the art to make and to use the inventive system concepts and methods.

GSM is a FDD-TDMA (Frequency-Division-Duplex-Time-Division-Multiplex-Access) system, each carrier occupying 200 kHz which is time shared by eight time slots or users. A typical example of the frequency channels and time slots is shown in FIG. 1.

The GSM slot structure for different types of slots (also called bursts) is illustrated in FIG. 2 (Refer to 3GPP TS 05.02, Release 99). There are 5 types of bursts: (1) a Normal burst to carry data and control information, (2) a Frequency correction burst used by a terminal for acquiring base station frequency information, (3) a synchronization burst used by a terminal to find downlink timing, (4) an Access burst used by a terminal for random access and handover access, and (5) a dummy burst used for rate adaptation and matching purposes. In early generation of GSM, for each burst/slot, a total of 156.25 bits are transmitted in 0.577 milliseconds, giving a gross bit rate of 270.833 kbps. In each normal burst/slot, 26 bits training sequence in the middle are used for channel tracking, 3 tail bits (TB) on both ends are used for reset the Viterbi equalizer state in a receiver, and the last 8.25 bits guard time allows power ramp up and down to handle some propagation time delay in the arrival of bursts to ensure that the data slots do not collide with each other.

The frames and slots numerology are illustrated in FIG. 3. Each group of eight time slots is called a TDMA frame, which is transmitted every 4.615 ms. TDMA frames are further grouped into multi-frames to carry control signals. There are two types of multi-frame, containing either 26 or 51 TDMA frames. The 26 frame multi-frame contains 24 Traffic Channels (TCH) and two Slow Associated Control Channels (SACCH) which supervises each call in progress. The SACCH in frame 12 contains eight channels, one for each of the eight connections carried by the TCHs. The SACCH in frame 25 is not currently used, but will carry eight additional SACCH channels when half rate traffic is implemented. A Fast Associated Control Channel (FACCH) works by stealing slots from a traffic channel to transmit power control and handover signaling messages. The channel stealing is done by setting one of the control bits in the burst.

In addition to the Associated Control Channels, there are several other control channels which (except for the Standalone Dedicated Control Channel) are implemented in time slot 0 of specified TDMA frames in a 51 frame multiframe, implemented on a non-hopping carrier frequency in each cell. These control channels include:
Broadcast Control Channel (BCCH): Continually broadcasts, on the downlink, information including base station identity, frequency allocations, and frequency hopping sequences etc.
Standalone Dedicated Control Channel (SDCCH): Used for registration, authentication, call setup, and location updating. Implemented on a time slot, together with its SACCH, selected by the system operator.
Common Control Channel (CCCH): Comprises three control channels used during the call origination and call paging.
   Random Access Channel (RACH): A slotted Aloha channel to request access to the network.
   Paging Channel: Used to alert the mobile station of incoming call.
   Access Grant Channel (AGCH): Used to allocate an SDCCH to a mobile for signaling, following a request on RACH.

The primary GSM is designed mainly for voice services. Other usage such as short massage is very powerful as well. We will briefly illustrate how to provide these two services before we describe the new services and new functionalities will be enabled within GSM network via this invention.

Full Rate Spread Coding: GSM is a digital system, so speech signals, inherently analog, have to be digitized. The GSM group studied several voice coding algorithms on the basis of subjective speech quality and complexity (which is related to cost, processing delay, and power consumption once implemented) before arriving at the choice of a Regular Pulse Excited—Linear Predictive Coder (RPELPC) with a Long Term Predictor loop. In practice, information from previous samples, which do not change very quickly, is used to predict the current sample. The coefficients of the linear combination of the previous samples, plus an encoded form of the residual (the difference between the predicted and actual sample), represent the signal. Speech is divided into 20 millisecond samples, each of which is encoded as 260 bits, giving a total bit rate of 13 kbps.

Recall that the speech codec produces a 260 bits block for every 20 ms speech sample. From subjective testing, it was found that some bits of this block were more important for perceived speech quality than others. The bits are thus divided into three classes:
Class Ia 50 bits—most sensitive to bit errors
Class Ib 132 bits—moderately sensitive to bit errors
Class II 78 bits—least sensitive to bit errors

Class Ia bits have three-bits Cyclic Redundancy Code added for error detection. If an error is detected in the receiver, the frame is judged too damaged to be comprehensible and it is discarded. It is then replaced by a slightly attenuated version of the previous correctly received frame. These 53 bits, together with the 132 Class Ib bits and a four-bit tail sequence (a total of 189 bits), are input into a 1/2 rate convolution encoder of constraint length four. Each input bit is encoded as two output bits, based on a combination of the previous four input bits. The convolution encoder thus outputs 378 bits, to which are added the 78 remaining Class II bits, which are unprotected. Thus every 20 ms speech sample is encoded as 456 bits, giving a bit rate of 22.8 kbps. FIG. 4 further illustrates how this process is implemented.

To further protect against the burst errors common to the radio interface, the 456 bits output from the convolution encoder are interleaved and then divided into eight blocks of 57 bits (refer to 3GPP TS 05.03, release 99), and these blocks are transmitted in eight consecutive timeslot bursts. Since each timeslot burst can carry two 57 bits blocks, each burst carries traffic from two successive speech blocks of 20 ms each. FIG. 5 illustrates this interleaving process in detail.

Each timeslot burst is transmitted at a gross bit rate of 270.833 kbps. The modulating symbol rate is 1/T=1,625/6 ksymbols/s (i.e. approximately 270.833 ksymbols/s). This digital signal is modulated onto the analog carrier frequency, which has a channel bandwidth of 200 kHz, using Gaussian Filtered Minimum Shift Keying (GMSK).

GMSK Modulation Start and Stop of the Burst (Refer 3GPP TS 05.04, Release 1999). Before the first bit of the burst, as defined in 3GPP TS 05.02, enters the modulator, the modulator has an internal state as if a modulating bit stream consisting of consecutive ones (di=1) had entered the differential encoder. Also after the last bit of the time slot, the modulator has an internal state as if a modulating bit stream consisting of consecutive ones (di=1) had continued to enter the differential encoder. These bits are called dummy bits and define the start and the stop of the active and the useful part of the burst. Nothing is specified about the actual phase of the modulator output signal outside the useful part of the burst.

FIG. 6 shows the relationship between active part of burst, tail bits and dummy bits. For the normal burst, the useful part lasts for 147 modulating bits.

GSM short message system (SMS) is defined in GSM 03.40 and GSM 03.41 which allows messages (advertising, public information, etc.) to be broadcast to all mobile users in a specified geographical area. Messages are sent to a Short Message Service Centre (SMSC) which provides a store-and-forward mechanism. It attempts to send messages to their recipients. If a recipient is not reachable, the SMSC queues the message for later retry. Both mobile terminated messages and mobile originating messages are supported.

A single short message can be up to 160 bytes (CDMA is longer and can be up to 256 bytes) of text in length. Those 160 characters can comprise words or numbers or an alphanumeric combination. Non-text based short messages (for example, in binary format) are also supported. These maybe used for ring tones and logos services.

The Short Message Service is a store and forward service, in other words, short messages are not sent directly from sender to recipient, but always go through an SMS center. Each mobile telephone network that supports SMS has one or more SMS messaging centers to handle and manage the short messages (refer to FIG. 9).

The short message service features confirmation of message delivery. This means that unlike paging, users do not simply send a short message and trust and hope that it gets delivered. Instead the sender of the short message can receive a return message back notifying them whether the short message has been delivered or not.

Short messages can be sent and received simultaneously with GSM voice, Data and Fax calls. Voice, Data and Fax calls take over a dedicated radio channel for the duration of the call while short messages will be carried over signaling channel which is usually well designed and well deployed and is more robust comparing to traffic channels. GSM control channels and SMS therefore form a powerful wireless managing and operating network for other wireless networks and systems.

A GSM device (refer to FIG. 10) comprise an antenna, a duplexer to be able to transmit and receive simultaneously, an RF processor to regulate the transmit signal and the receive signal in analog format, a baseband processor to encode the signal for transmit and to decode the received signal and a coprocessor for L2/L3/MAC processing and a SIM (Sub Scriber Identification Module) to personalize the device.

To response those future requirements, various exemplary embodiments are convenient to implement and are efficient in terms of hardware implementation and future wireless network convergence by integrating technologies of different standards.

The invention provides systems and methods to manage batteries and power consumption in network level to significantly save the energy and reduce the unnecessary RF pollution.

The invention also provides solutions to bridge different products basing on different wireless standards and using different spectrums.

The invention further provides a cost effective solution for wireless networks convergence under GSM network or other wireless network.

Various exemplary embodiments are systems and methods and apparatus that exploit GSM as an operation means to mange other wireless networks and technologies.

Embodiments provide the system architecture on how to re-use GSM network to operate and coordinate other wireless networks and systems to work together.

Still other embodiments employ GSM to operate local networks such as WiFi or Femto networks or home gateways.

Still another embodiment that GSM coordinates the data delivery via multiple wireless networks.

### 4. DESCRIPTION OF DRAWINGS

The present invention will be further understood from the following detailed description with reference to the following drawings:

FIG. 1 illustrates a known GSM FDD-TDMA channel allocation.

FIG. 2 illustrates 5 typical GSM slot/burst types.

FIG. 3 illustrates GSM slot/frame numerology.

FIG. 4 illustrates GSM full rate speech coding process.

FIG. 5 illustrates how 20 ms voice coded bits are interleaved within 8 consecutive frames.

FIG. 6 illustrates the start and stop of a GSMK burst.

FIG. 7 illustrates 8-PSK modulation and gray mapping used in EDGE (Enhanced Data rate for GSM Evolution).

FIG. 8 illustrates the start and stop of each burst with 8-PSK modulation.

FIG. 9 illustrates a typical SMS network architecture.

FIG. 10 describes a typical GSM device which mainly comprises an antenna, RF chains for transmit and receive, a baseband processor to process the data, a co-processor to process the MAC/L2 protocols and a SIM (Subscriber Identification module) card to personalize the GSM device.

FIG. 11 exemplifies a GSM operated handset with a GSM device built in as an operator for other devices or modules.

FIG. 12 exemplifies a Femto/Home Gateway with a GSM device built in as an operator for other devices or modules.

FIG. 13 Illustrates a GSM operated handset with GSM connection always on and turn on/off other connections via GSM network.

FIG. 14 Illustrates a GSM operated handset using GSM device to coordinate other devices to receive data from multiple networks.

FIG. 15 Illustrates a GSM operated handset using GSM device to coordinate other devices and networks to transmit data to another GSM operated handset or multiple handsets.

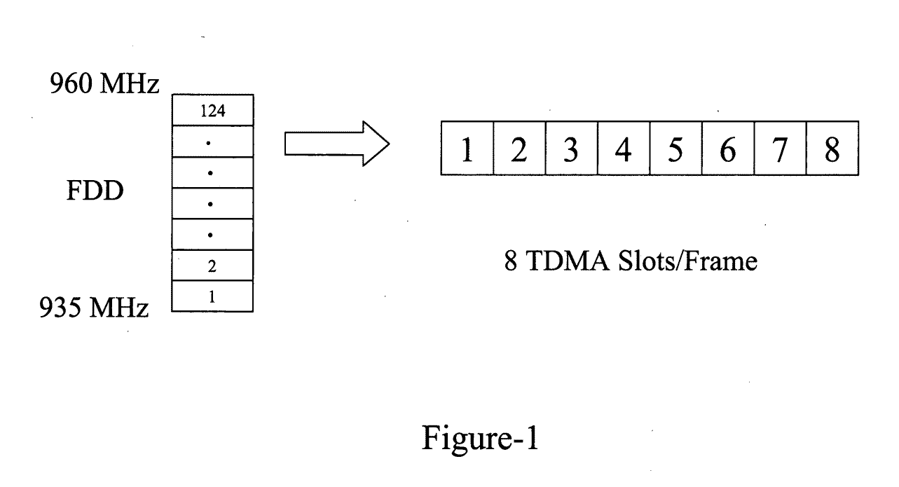

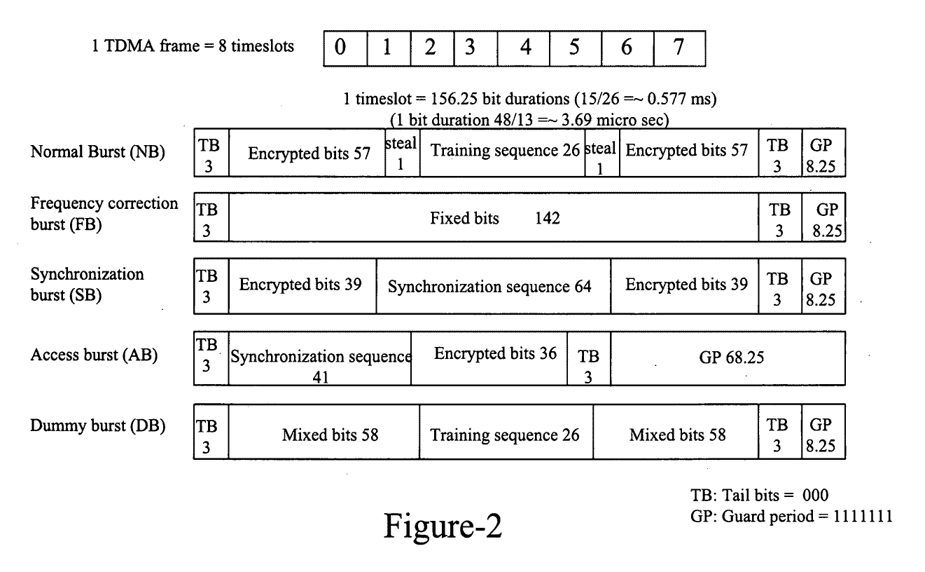

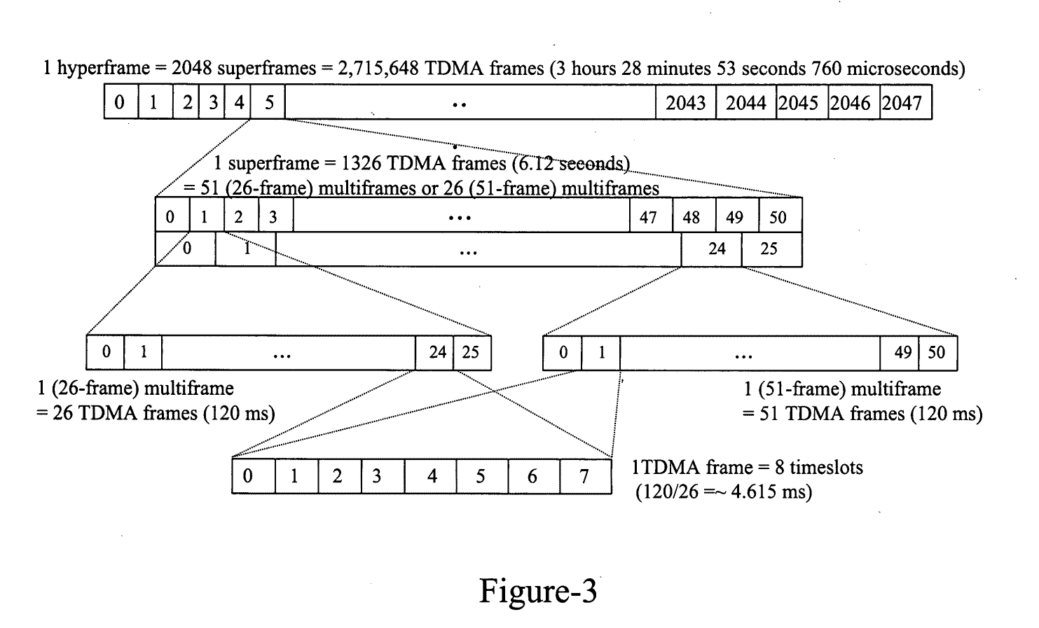

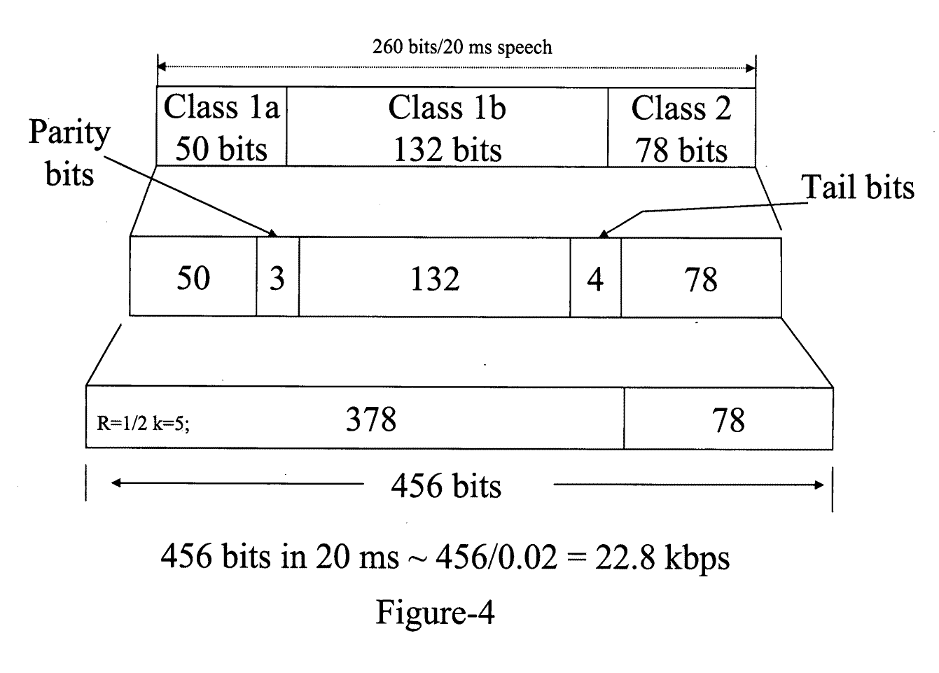

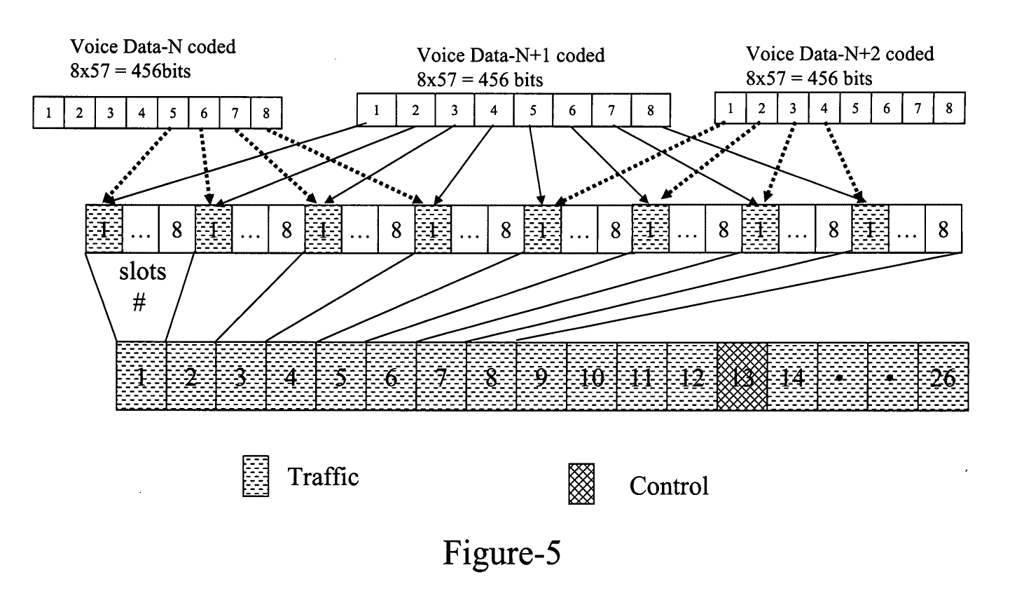

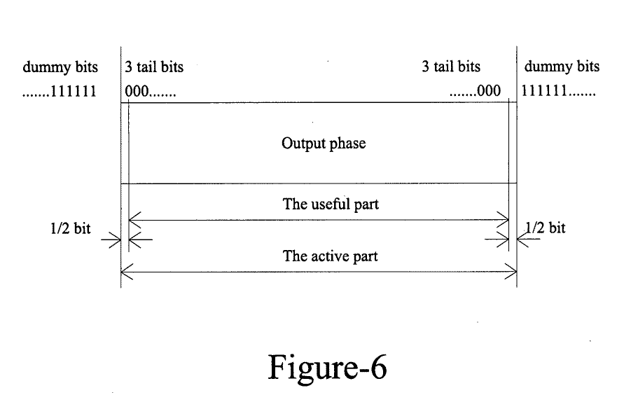

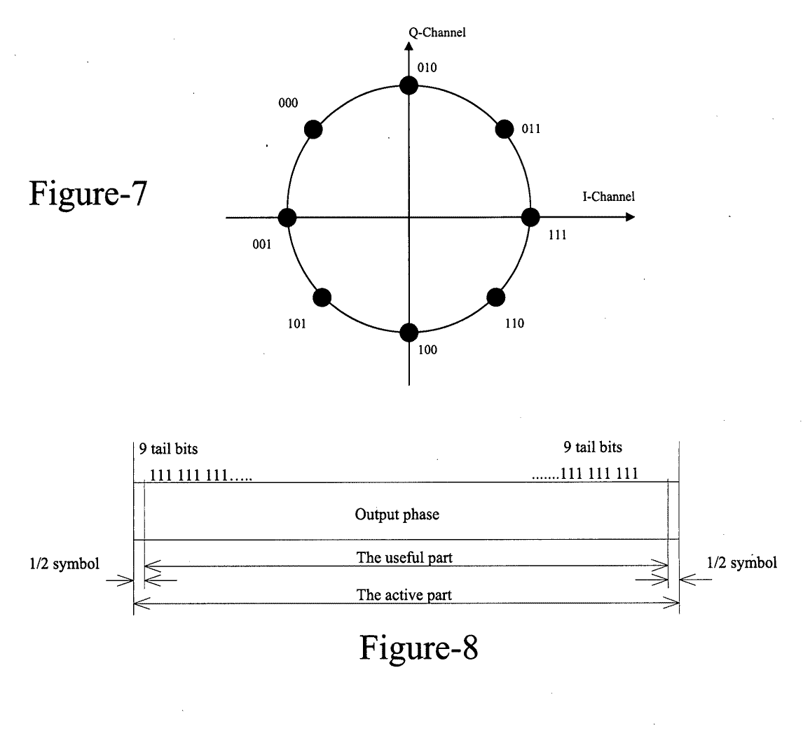

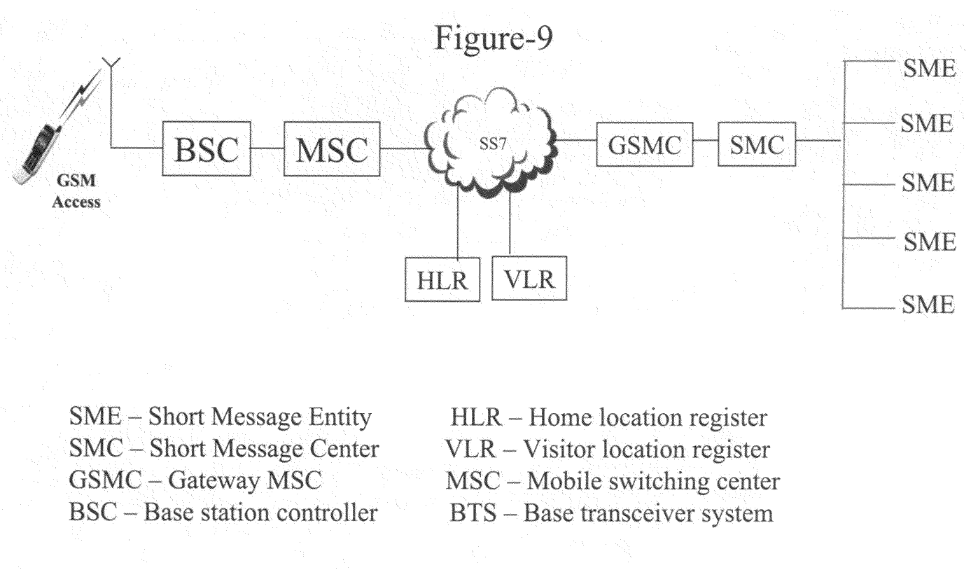

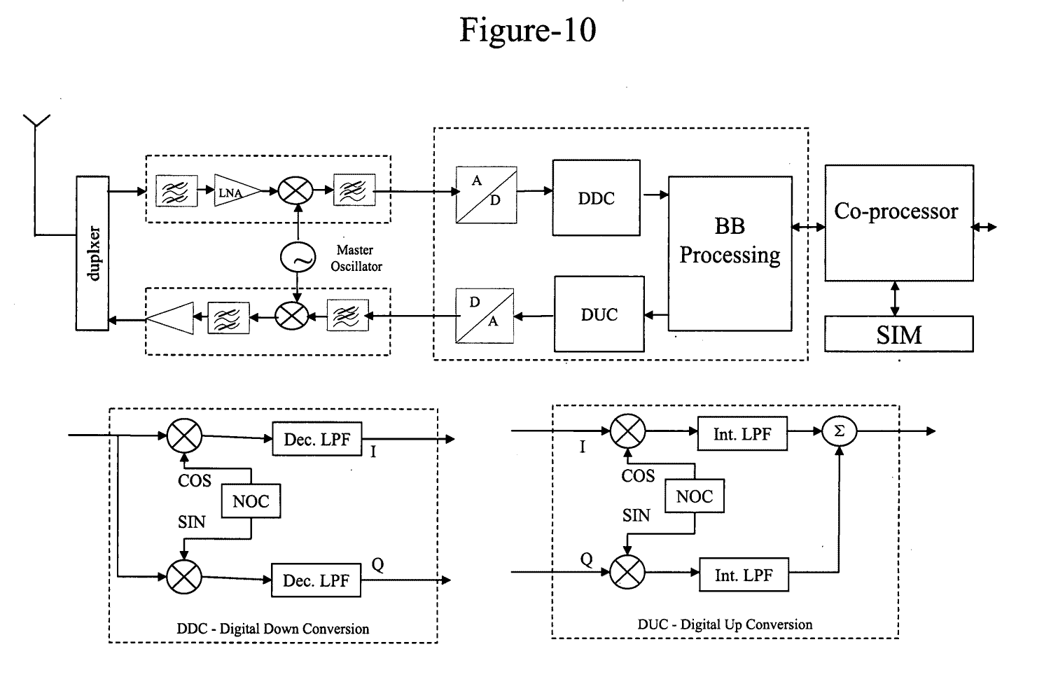

### 5. DETAILED DESCRIPTION OF THE INVENTION

The conventional smart handset design usually to integrate multiple wireless technologies together. Although those technologies may share some common resources such as processor, battery and memory etc., each technology operates independently. For example, some phone may have both GSM technology and WiFi/802.11g technology. When both GSM radio and WiFi radio get turned on, they run independently or only one runs at a time. GSM can be quickly connected to GSM network due to its popularity and wireless operators' big effort in coverage provision in the past 15 years. The problem arises from WiFi radio as it will continuously search an AP (Access Point) for connection even if there is no AP nearby. This blindly-trial for connection consumes a big portion of the battery. The conventional AP or home gateway, on the other hand, has been radiating RF energy constantly whether there is a user connecting to it or not. This is wasting the energy meanwhile causing the RF pollution. This invention will illustrate how to utilize GSM to resolve those critical problems and to make a convergence of all the existing and emerging wireless technologies.

We will describe each embodiment of the invention in details.

In one embodiment of the invention, a GSM operated handset always includes a GSM device as a master device which always connects to a GSM network.

In one embodiment, a GSM operated handset comprises a LTE device, a HSPA device, a WiFi device, a WiMax device, an ATSC device, a DVB-T device, a DVB-H device, a BlueTooth device and GPS device etc. and those devices maybe turned on/off via GSM device's instructions.

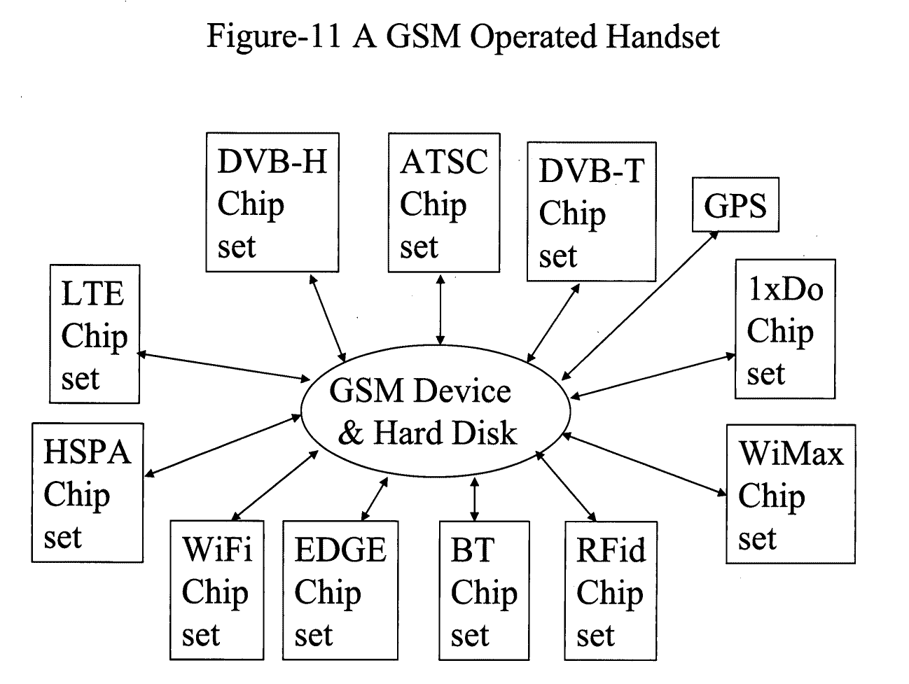

In FIG. 11, a GSM operated handset comprises a GSM device and several other devices such as WiFi device, LTE device, HSPA device, WiMax device etc. GSM device connects to other devices and can communicate with them.

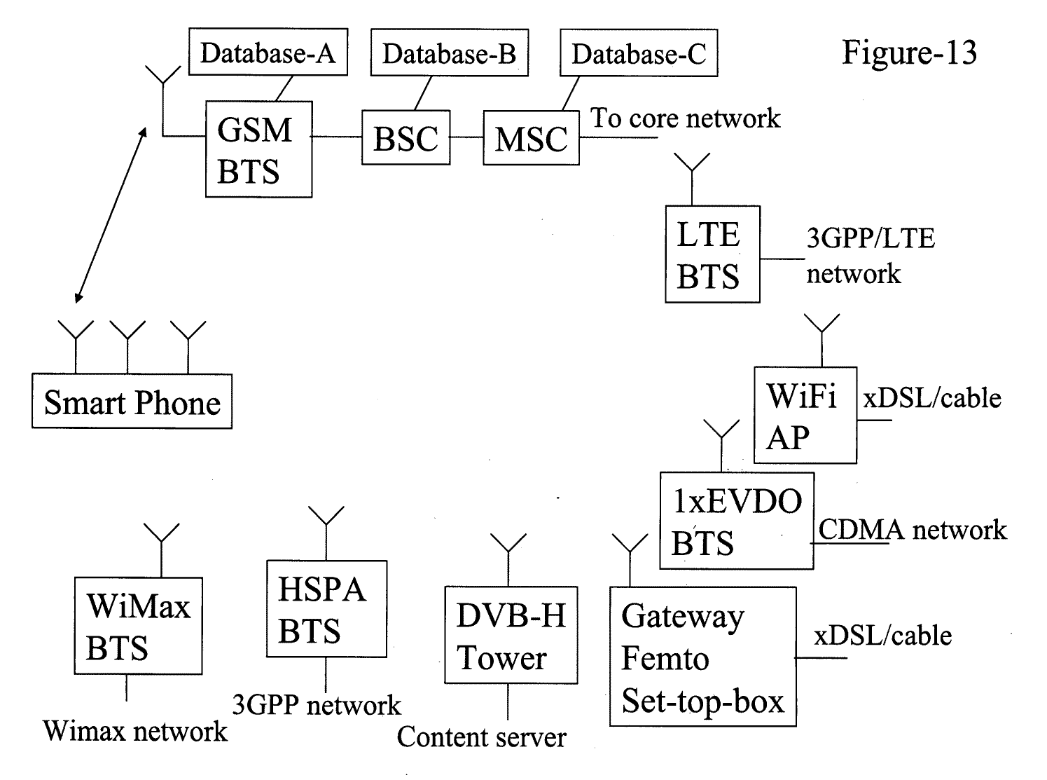

In normal operation, only GSM device of a GSM operated handset maybe turned on and active and all other devices maybe turned off or keep in inactive mode (refer to FIG. 13).

In one embodiment, GSM BTS may specify a channel to broadcast its neighborhood information such as LTE access availability, WiFi access availability, HSPA access availability, spectrum availability, interference scenarios, regulation rules etc.

In another embodiment, GSM BTS may inform a particular GSM device built into a GSM operated handset about the services availability surrounding it and handset GSM device will decide to turn on/off another available device or display that information on the screen, by LED or a beep, or a text.

In one embodiment, GSM network may issue a command to handset GSM device to turn on/off another device.

In another embodiment, GSM network may issue a command to handset GSM device to inform another device to change frequency or change the power level or to change transmit/receive schedules etc.

In one embodiment, handset GSM device will acquire location information from another unit such as a GPS device or a geo-location module and report its location update to its associate BTS and BTS will return a message of its surrounding services availability and GSM operated handset GSM device either take action to turn on/off a device or shows that information to its user.

Still in another embodiment, handset GSM device will inquire its location and compare the stored locations in the memory to determine to turn on/off a device or push that information to the user.

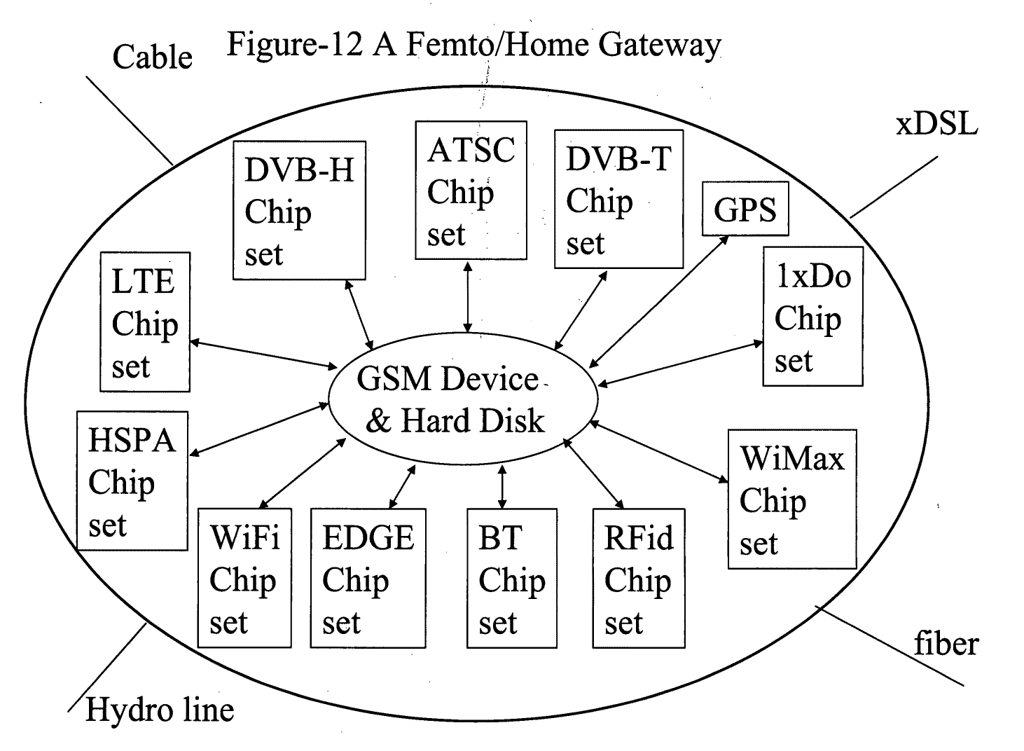

In FIG. 12, a Femto or WiFi AP or a home gateway or a small BTS always has a built in GSM device which is always connected to a GSM network and GSM device is a master and other devices are slaves.

In one embodiment, handset GSM device will inquire its location and compare the stored locations in the memory. Then handset GSM device sends a message to turn on/off another radio of an AP, a Femto or a home gateway or a small BTS via a short message or other signaling message or change their transmit/receive parameters such as frequency, time offset, power level or antenna beam pattern etc.

In FIG. 13, GSM network is equipped a database server which may co-locate with a BTS or a BSC (Base Station Controller) or a MSC (Mobile Switching Center) and GSM network connects to other networks via backhauls (didn't show in the figure) of fiber, T1/E1, xDSL, microwave etc.

Still in another embodiment, the database comprises hot spot geolocations, frequencies availability, coverage ranges, Femto/Gateway geolocation, technology types, frequencies and coverage, occupied TV broadcast channel numbers, power level limitation and usage etiquettes, interference scenarios, regulation policies etc.

Advantageously, other battery and power hungry devices maybe turned off when they are not in use or not in their service coverage.

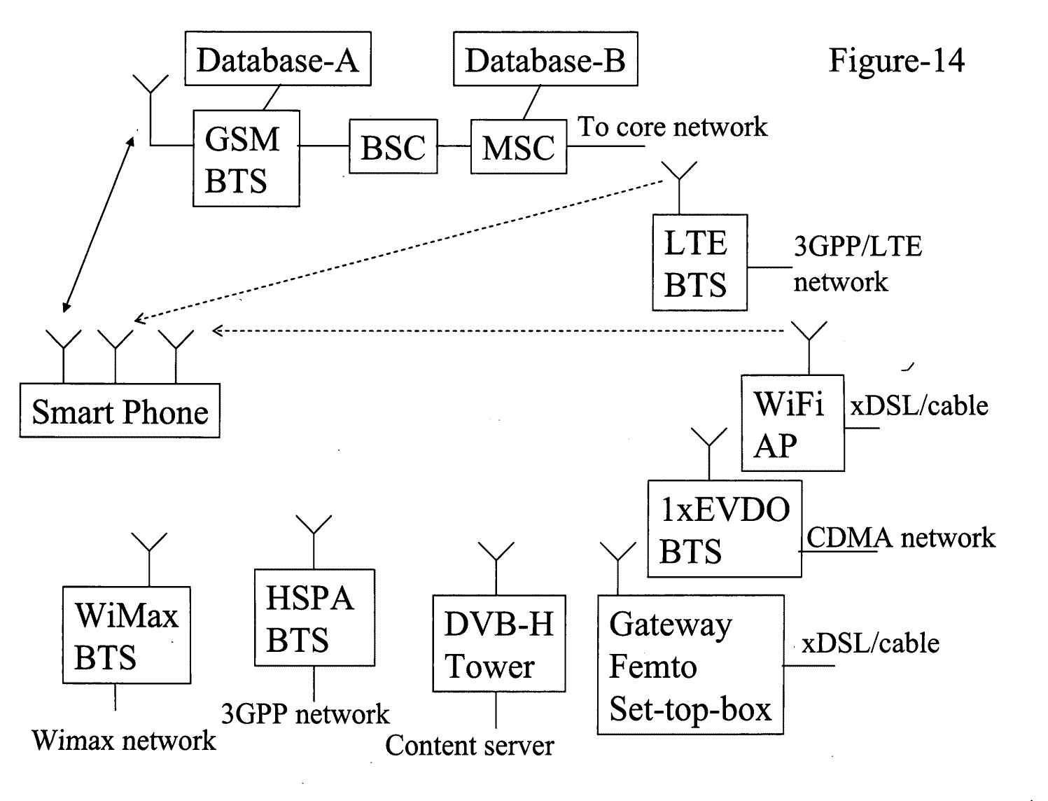

In one embodiment of FIG. 14, handset GSM device can turn on multiple other devices to receive and meanwhile coordinate multiple wireless networks to deliver data to the same handset.

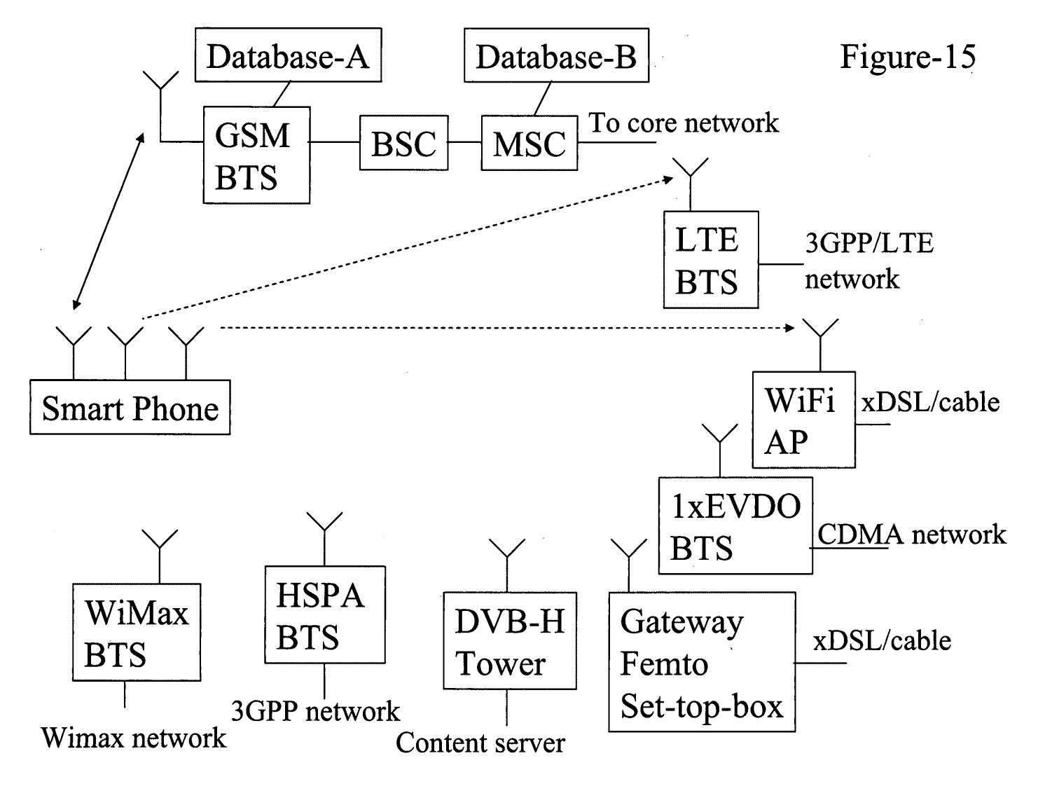

In another embodiment of FIG. 15, handset GSM device can turn on multiple other devices to transmit meanwhile coordinate multiple wireless networks to deliver data to another intended handset or multiple receivers.

Advantageously, GSM network may be gradually degenerated to be a signaling network while gives away a portion of GSM traffic spectrum to other spectrum more efficient technologies such as HSPA or LTE or WiMax or WiFi.

We claim:

1. A GSM operated handset comprises a GSM device as a master device which may control the other slave wireless devices connecting to it; A GSM operated access point or femto or home gateway comprises a GSM device as a master device and all other wireless devices as slave devices; the slave wireless devices may include LTE, WiMax, WiFi, HSPA, GSM EDGE, ATSC, DVB-H, DVB-T, BlueTooth, RFid, GPS etc.

2. A GSM device of a GSM operated handset as claimed in claim 1 is always connected to GSM network and inquires and receives information from GSM network and triggers other devices to turn on or to turn off or to re-configure their transmitting and receiving parameters.

3. A GSM device of a GSM operated handset as claimed in claim 1 is always connected to GSM network and updates its location information and checks its database stored in a memory unit and instructs other devices to turn on or off.

4. A database as claimed in claim 3 may contain home geolocation, offices locations, hot spots locations, IDs, last connected AP/Femto locations or signatures, frequencies occupation information, signal strength, coverage information, interferences information, power levels, usage policies, unused TV channel information or protected TV channels numbers etc.

5. A GSM device of a GSM operated handset as claimed in claim 1 informs a GSM operated access point or a Femto or a set top box to turn power on when it is approaching it and to turn power off when it is leaving it via another GSM device.

6. An access point or a Femto or a set top box as specified in claim 5 may turn off the power after receiving the instructions from all the handsets associated to it.

7. A GSM device of a GSM operated access point as claimed in claim 1 may receive a message or a command from GSM network to turn on or to turn off other devices connecting to it or to change their transmit/receive parameters.

8. A GSM device as claimed in claim 7 may receive a message originating from another GSM device to turn on or to turn off other devices connecting to it or to change their transmit/receive parameters.

9. A GSM device as claimed in claim 7 may receive a message originating from a network manager or a database sever to turn on or to turn off other devices connecting to it or to change their transmit/receive parameters.

10. A GSM base station or a BSC or a MSC may be associated with a database server which records and updates information of other wireless services availability.

11. The database as claimed in claim 10 may contain AP/Femto/Home gateways geolocation IDs, and coverage information, frequency information, antenna height information, user density information, frequency usage policies and etiquettes, interference and propagation scenarios, relay nodes, multiple antenna coordination and configuration parameters, backhaul capacity information, etc.

12. The database sever as claimed in claim 10 may send commands to other devices of a Femto base station, small base station or home gateway via another GSM device to change other devices transmit or receive parameters such as frequency, time, power level or turn on or turn off.

13. A GSM operated handset as claimed in claim 1 comprising a GSM device which turns on multiple other wireless devices connecting to it and coordinates with other available wireless networks to deliver data or services simultaneously to another handset.

14. A GSM device as claimed in claim 13 sends a message to a content sever to divide that data packet into multiple parts and each part will be delivered via a wireless network (refer to FIG. 14).

15. A GSM device as claimed in claim 13 turns on multiple other wireless devices connecting to it and then sends a message to another GSM operated handset to turn on same set of multiple devices to be in receiving mode and informs the coprocessor to divide a data packet into multiple packets and each sub-packet will be transmitted with a device enabled (refer to FIG. 15).

16. Another GSM operated handset as claimed in claim 15 will reassemble the received sub-packets to recover the original message or data packet.
